(19) United States
(12) Patent Application Publication
(10) Pub. No.: US 2018/0292839 A1
(43) Pub. Date: Oct. 11, 2018

(54) HIDDEN SATELLITE SIGNAL REJECTION FOR AUTOMATED VEHICLE NAVIGATION SYSTEM

(71) Applicant: Delphi Technologies, Inc., Troy, MI (US)

(72) Inventors: Junqing Wei, Bridgeville, PA (US); Jarrod M. Snider, Pittsburgh, PA (US); Jonathan L. Wieskamp, Santa Clara, CA (US)

(21) Appl. No.: 15/480,531

(22) Filed: Apr. 6, 2017

(51) Int. Cl. G05D 1/02; G01S 19/46; G01S 19/45; G01S 19/42

(52) U.S. Cl. CPC G05D 1/0274; G01S 19/42; G01S 19/45; G01S 19/46

(57) ABSTRACT

A navigation system for an automated vehicle includes a receiver, a three-dimensional-model (3D-model), and a controller. The receiver detects signals from satellites for determining a location of a host-vehicle on a digital-map. The 3D-model depicts objects in an area proximate the host-vehicle. The controller is in communication with the receiver and the 3D-model. The controller ignores a signal of a satellite detected by the receiver when the satellite is determined to be hidden by an object in the 3D-model.

### TECHNICAL FIELD OF INVENTION

This disclosure generally relates to a navigation system for an automated vehicle, and more particularly relates to a system that ignores a signal of a satellite detected by a receiver when the satellite is determined to be hidden by an object in a 3D-model of the area proximate to the receiver.

### BACKGROUND OF INVENTION

It is known that relatively tall objects such as buildings and mountains can block global-positioning-system (GPS) signals from satellites. That is, the line-of-site from a satellite to a GPS-receiver can be blocked by such objects. However, the GPS signals from satellites can be reflected by other objects such as buildings, which can cause GPS positioning errors.

### SUMMARY OF THE INVENTION

In accordance with one embodiment, a navigation system for an automated vehicle is provided. The system includes a receiver, a three-dimensional-model (3D-model), and a controller. The receiver detects signals from satellites for determining a location of a host-vehicle on a digital-map. The 3D-model depicts objects in an area proximate the host-vehicle. The controller is in communication with the receiver and the 3D-model. The controller ignores a signal of a satellite detected by the receiver when the satellite is determined to be hidden by an object in the 3D-model.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a diagram of a navigation system in accordance with one embodiment; and

FIG. 2 is illustration of an environment/3D-model in which the system of FIG. 1 operates in accordance with one embodiment.

### DETAILED DESCRIPTION

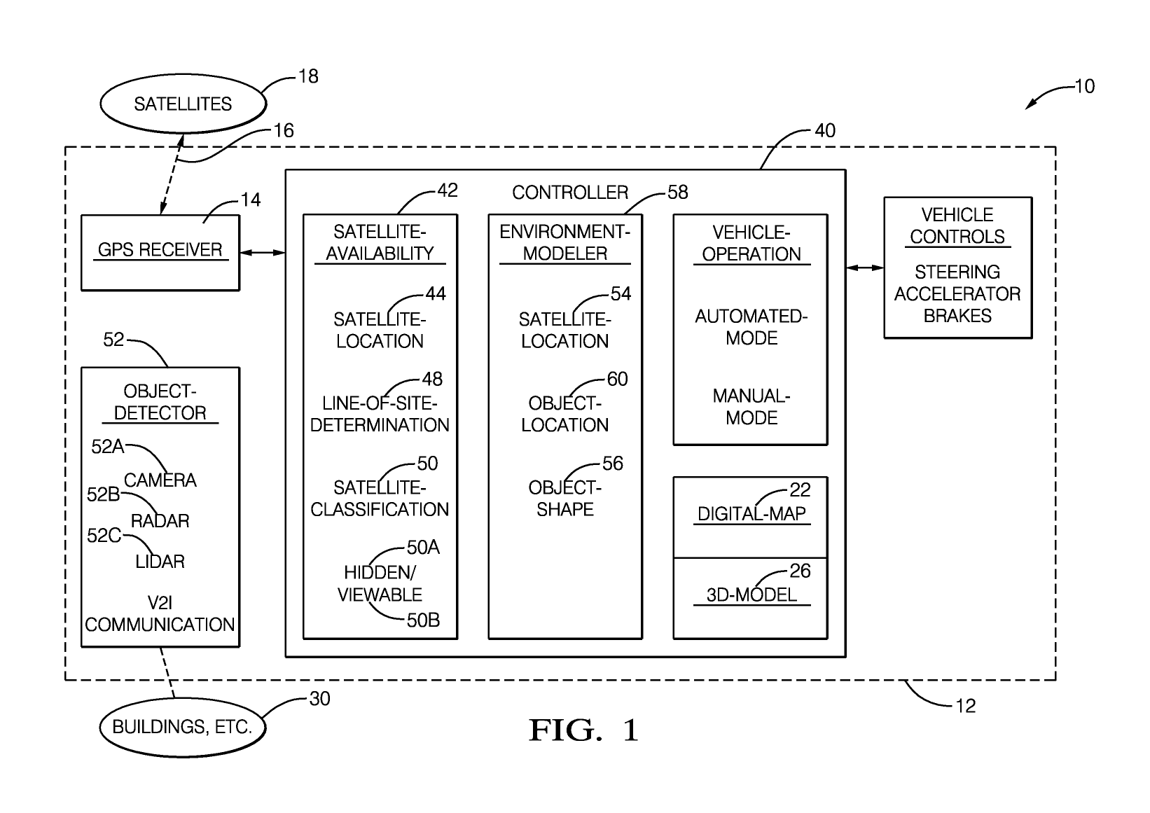

FIG. 1 illustrates a non-limiting example of a navigation system 10, hereafter referred to as the system 10, which is suitable for use by an automated vehicle, a host-vehicle 12 for example. As used herein, the term automated vehicle may apply to instances when the host-vehicle 12 is being operated in an automated-mode, i.e. a fully autonomous mode, where a human-operator (not shown) of the host-vehicle 12 may do little more than designate a destination in order to operate the host-vehicle 12. However, full automation is not a requirement. It is contemplated that the teachings presented herein are useful when the host-vehicle 12 is operated in a manual-mode where the degree or level of automation may be little more than providing an audible or visual warning to the human-operator who is generally in control of the steering, accelerator, and brakes of the host-vehicle 12.

In general, the system 10 described herein is an improvement over prior navigation systems that receive global-positioning-system (GPS) signals from satellites 18 because the system 10 is able to determine which signals are received via a line-of-site to a particular satellite, i.e. are not a multi-path receptions, and which signals are likely received after being reflected by some object, i.e. are a multi-path receptions. This improvement avoids the aforementioned GPS positioning errors caused by multi-path signals.

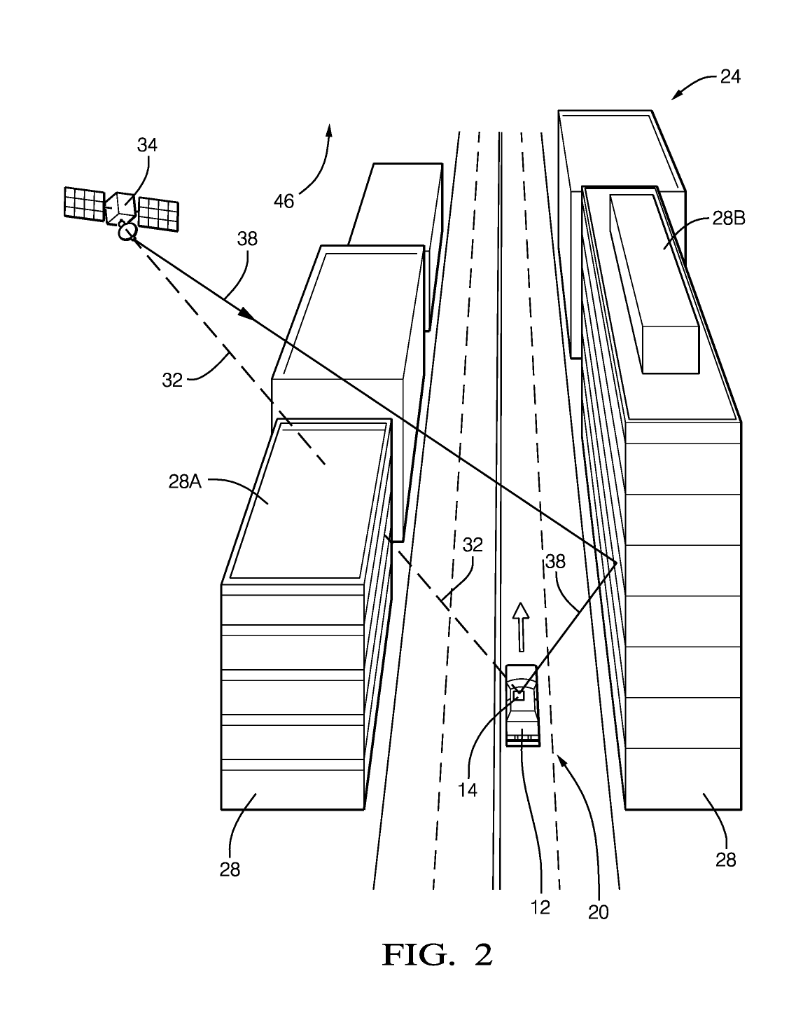

The system 10 includes a GPS receiver, hereafter referred to as the receiver 14, that detects instances of signals 16 from satellites 18 for determining a location 20 (FIG. 2) of the host-vehicle 12 on a digital-map 22. The method by which the location 20 on the digital-map 22 is determined from the signals 16 is well-known to those in the navigation arts.

FIG. 2 illustrates a non-limiting example of an environment 24 in which the host-vehicle 12 may travel. The system 10 includes a three-dimensional-model, hereafter referred to as the 3D-model 26 (FIG. 1). The 3D-model 26 generally corresponds to, i.e. includes much or all of the information in, the illustration of the environment 24 shown in FIG. 2. For example, the 3D-model 26 depicts instances of objects 28 such as buildings, mountains, and other objects in an area 30 proximate the host-vehicle 12. As will be explained in more detail below, the system 10 uses the 3D-model 26 to determine when a line-of-site 32 between a satellite 34 and the host-vehicle 12 is blocked by an object 28A such as the building shown in FIG. 2. That is, the system 10 determines when the signal 38 received by the receiver 14 is a multi-path signal, i.e. has arrived at the receiver 14 by reflection rather than via a line-of-site from the satellite 34 to the receiver 14.

While FIG. 1 may be interpreted to suggest that the 3D-model 26 is stored in the host-vehicle 12, possibly as part of the digital-map 22, this is not a requirement. Because of the potential size of a 3D-model that covers the same area as a typical example of the digital-map 22 (typically a two-dimensional (2D) depiction of roadways and points-of-interest), it is contemplated that the 3D-model 26 could be stored ‘in the cloud’, and a portion of that 3D-model proximate to, for example within ten kilometers of, the host-vehicle 12 may be downloaded as needed. It is recognized that there is on-going development to provide a 3D-model that does not require large amounts of storage to cover the range of a typical digital-maps found in available navigation systems. That is, it is contemplated that the digital-map 22 could include the 3D-model 26.

The system 10 includes a controller 40 in communication with the receiver 14 and the 3D-model 26. The controller 40 may include a processor (not specifically shown) such as a microprocessor or other control circuitry such as analog and/or digital control circuitry including an application specific integrated circuit (ASIC) for processing data as should be evident to those in the art. The controller 40 may include memory (not specifically shown), including non-volatile memory, such as electrically erasable programmable read-only memory (EEPROM) for storing one or more routines, thresholds, and captured data. The one or more routines may be executed by the processor to perform steps for determining when a line-of-site 32 between a satellite 34 and the host-vehicle 12 is blocked by an object 28A.

It follows that the controller 40 is generally configured, i.e. programmed, to ignore the signal 38 from the satellite 34 that is detected by the receiver 14 when the satellite 34 is determined to be hidden or blocked or obstructed by the object 28A in the 3D-model 26. The controller 40 may be configured to determine a satellite-availability 42 by consulting a table or listing that provides a satellite-location 44 for each of the satellites 18 from which the receiver 14 could receive a signal if the host-vehicle 12 had a completely unobstructed view of the sky 46 all of the way to the horizon from the location 20 of the host-vehicle 12. Then by using the 3D-model 26 the controller 40 makes a line-of-site-determination 48 to determine if the line-of-site 32 is or is not obstructed by one or more of the objects 28.

Based on the line-of-site-determination 48, a satellite-classification 50 may be assigned to each of the possible satellites indicated by the satellite-availability 42, where the satellite-classification 50 may be one of hidden 50A and viewable 50B. That is, the controller 40 may, based on the 3D-model 26, pre-determine the satellite-classification 50 of each of the satellites 18 that the receiver 14 could receive before any signal is received from a particular instance of the satellites 18, e.g. the satellite 34, and then if the signal 38 is received, it is already known if the signal 38 should be ignored.

As shown in FIG. 2, the object 28A blocks the line-of-site 32 between the satellite 34 and the receiver 14 on the host-vehicle 12. Accordingly, the controller 40 sets the satellite-classification 50 to hidden 50A. Then if the signal 38 is detected by the receiver 14 because the signal 38 was reflected by the reflecting-object 28B, the signal 38 is ignored. As the host-vehicle 12 travels in the direction shown, the object 28A will cease to obstruct or block the line-of-site so the satellite-classification 50 will be changed to viewable 50B. As such, the controller 40 may be configured to update the satellite-classification 50 on a periodic basis (time or distance) or after it is known that the line-of-site 32 is no longer obstructed by the object 28A.

It is recognized that the signal 38 may still be detected by the receiver in addition to a direct-signal (not shown) along a subsequent-line-of-site (not shown) after the host-vehicle 12 passes the object 28A. The process by which the signal 38 that is a multi-path signal is separated or distinguished from the direct-signal (not a multi-path signal) is known to those in the navigation arts.

It is contemplated that the 3D-model 26 may not be available for some locations, or may be in error because, for example, a building has recently been constructed or razed. To overcome this problem, the system 10 may include an object-detector 52 that may be used by an environment-modeler 58 in the controller to form the 3D-model 26 as needed, or make/report corrections to the 3D-model as necessary. The object-detector 52 may include one or more of (i.e. any combination of) a camera 52A, a radar 52B, and a lidar 52C. For example, the camera 52A may be used to determine an object-identification 54 by comparing an image rendered by the camera 52A to a collection of images and selecting based on similarities. Furthermore, the radar 52B and/or the lidar 52C may be used to determine an object-shape 56 of an object detected by the object-detector 52 that is not present in the 3D-model 26. Once the object-identification 54 and/or the object-shape 56 are determined, an object-location 60 may be determined based on the location 20, which may also be provided to update the 3D-model 26.

The object-detector 52 may also include a vehicle-to-infrastructure (V2I) transceiver that can be used to request updates from an information broadcaster at a construction-site where a building is being constructed or razed so that up-to-the-minute updates to the 3D-model 26 can be provided. The V2I transceiver may also be used to report discrepancies of the 3D-model so an other-vehicle traveling on the same roadway at a later time can be notified.

Accordingly, a navigation system (the system 10), a controller 40 for the system 10, and a method of operating the system 10 is provided. The system 10 avoids GPS localization errors by ignoring signals from satellites that are not received by a line-of-site route.

While this invention has been described in terms of the preferred embodiments thereof, it is not intended to be so limited, but rather only to the extent set forth in the claims that follow.

We claim:

1. A navigation system for an automated vehicle, said system comprising:
a receiver that detects signals from satellites for determining a location of a host-vehicle on a digital-map;
a three-dimensional-model (3D-model) that depicts objects in an area proximate the host-vehicle; and
a controller in communication with the receiver and the 3D-model, wherein the controller ignores a signal of a satellite detected by the receiver when the satellite is determined to be hidden by an object in the 3D-model.

2. The system in accordance with claim 1, wherein the 3D-model is used to determine a line-of-site between the satellite and the host-vehicle, and the satellite is classified as hidden when the line-of-site is blocked by the object.

3. The system in accordance with claim 1, wherein the digital-map includes the 3D-model.

4. The system in accordance with claim 1, wherein the system includes an object-detector used to form the 3D-model.

5. The system in accordance with claim 2, wherein the object-detector includes one or more of a camera, a radar, and a lidar.
